(19) United States
(12) Patent Application Publication
(10) Pub. No.: US 2011/0185621 A1
(43) Pub. Date: Aug. 4, 2011

(54) TRANSPORTABLE FISHING POLE HOLDER

(76) Inventor: Larry Lamb, San Bernardino, CA (US)

(21) Appl. No.: 13/020,448

(22) Filed: Feb. 3, 2011

Related U.S. Application Data
(60) Provisional application No. 61/301,014, filed on Feb. 3, 2010.

(51) Int. Cl. A01K 97/10

(52) U.S. Cl. 43/21.2

(57) ABSTRACT

Embodiments of the invention are directed to transportable fishing rod holders. In one embodiment, a transportable fishing rod holder is defined by a frame having two opposing horizontally-oriented members with a vertically-oriented member situated therebetween. A securing mechanism secured to a bottom of the frame may be used to temporarily drive the frame into the ground by a user. A removable panel may be secured to the frame by a locking mechanism in a first position, or carrying position, and may be secured by a cantilever mechanism in a second position, or user position. The frame and/or the panel may have one or more holders to hold one or more fishing poles.

### CLAIM OF PRIORITY UNDER 35 U.S.C. §119

This application claims the benefit of U.S. Provisional Application Ser. No. 61/301,014 filed Feb. 3, 2010.

### FIELD OF INVENTION

At least one feature pertains to fishing pole holders.

### BACKGROUND OF INVENTION

Fishing is both a sport and a means of livelihood for persons all over the world. Generally, fishing can be performed from a boat or from land. “Bank fishing” refers to fishing from land, i.e., fishing from the bank of a river or a lake shoreline. As the fishermen generally remains in the same or approximately the same area for a time period while bank fishing, such fishing requires a lot of time and patience. As a result, many fishermen prop their fishing poles in a stationary position and only tend to the pole when there is a fish tugging the line and/or when re-casting the line.

Conventional fishing pole holders for bank fishing (“bank rod holders”) generally comprise a single spike with a retaining arm or a single tubular holder. Such bank rod holders must often be driven into the ground to hold the fishing pole. For conventional bank rod holders, this can be challenging when the ground is hard or impacted or if the holder hits a rock. In some cases, such holders even bend due to their lightweight construction.

Consequently, a bank rod holder which alleviates problems associated with conventional bank rod holders is needed.

### SUMMARY OF INVENTION

A transportable fishing rod holder, comprising: (a) a first member; (b) a second member perpendicularly-attached at a proximal end of the first member at a middle of the second member, the second member including at least one angled holder at an end thereof; (c) a third member perpendicularly-attached at a distal end of the first member at a middle of the third member; (d) a securing mechanism having a dual-prong configuration adapted to secure in the ground, the securing mechanism attached to at least the third member at the middle thereof and perpendicularly-oriented relative to the third member; and (e) a removable panel having a slit-like opening therein and adapted to secure to the first member by a locking mechanism in a first position, the removable panel having at least one vertically-oriented holder attached thereto is herein disclosed.

The removable panel may be adapted to secure to the first member by a retaining mechanism in a second position. In some embodiments, the first, second and third members and the securing mechanism are comprised of metal rods. The angled holder may be adapted to hold a handle of a fishing pole. The vertically-oriented holder may be adapted to hold a handle of a fishing pole. The second member may include two angled holders at either end thereto. In one embodiment, the panel includes two vertically-oriented holders.

### BRIEF DESCRIPTION OF DRAWINGS

FIG. 1 is a front view of a transportable fishing rod holder with fishing rods in use according to an embodiment of the invention.

FIG. 2 is a perspective view of the transportable fishing rod holder 100 of FIG. 1 with panel 112 in a second position.

FIG. 3 is a perspective view of securing mechanism 122 which may be integral with the transportable fishing rod holder 100 of FIG. 1 and used to secure rod holder 100 into the ground.

FIG. 4 is a front view of the transportable fishing rod holder 100 of FIG. 1 with fishing rods in storage.

FIG. 5 is a view of the rod holder 100 being transported.

### DETAILED DESCRIPTION

The following detailed description is of the best currently contemplated modes of carrying out the invention. The description is not to be taken in a limiting sense, but is made merely for the purpose of illustrating the general principles of the invention.

Embodiments of the invention are directed to transportable fishing rod holders. In one embodiment, a transportable fishing rod holder is defined by a frame having two opposing horizontally-oriented members with a vertically-oriented member situated therebetween. A securing mechanism secured to a bottom of the frame may be used to temporarily drive the frame into the ground by a user. A removable panel may be secured to the frame by a locking mechanism in a first position, or carrying position, and may be secured by a cantilever mechanism in a second position, or user position. The frame and/or the panel may have one or more holders to hold one or more fishing poles.

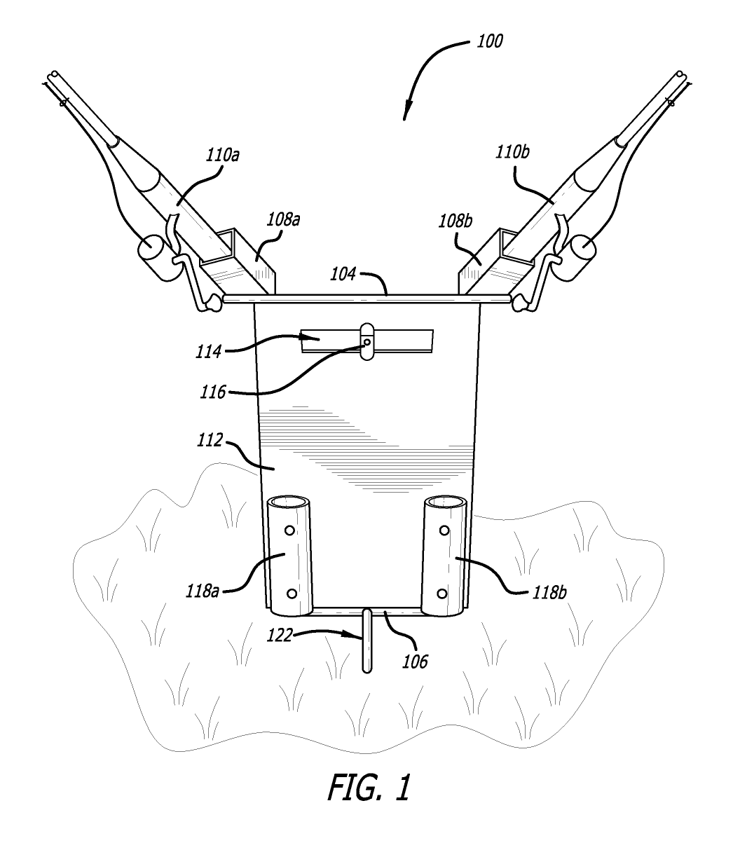

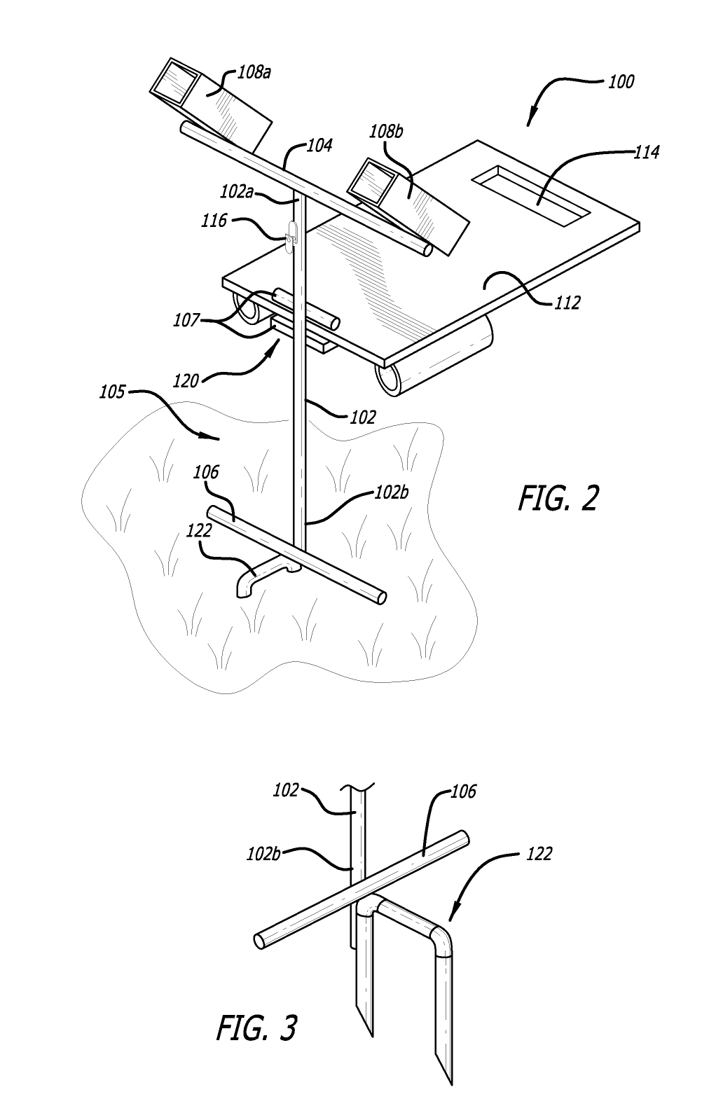

FIG. 1 is a front view of a transportable fishing rod holder with fishing rods in use according to an embodiment of the invention. According to one embodiment, rod holder 100 includes a first member 102 (not shown; see FIG. 2), a second member 104 perpendicularly-oriented relative to a proximal end 102a of first member 102, and a third member 106 perpendicularly-oriented relative to a distal end 102b of first member 102. The proximal end 102a of first member 102 may be permanently or adjustably attached at approximately a middle of the second member 104. Similarly, the distal end 102b of first member 102 may be permanently or adjustably attached at approximately a middle of the third member 106.

In some embodiments, first, second and third members 102, 104 and 106, respectively, are made of steel, a composite material or any other suitable material. In one embodiment, first, second and third members 102, 104 and 106, respectively, are steel rods welded at the respective locations discussed above. In some embodiments, first, second and third members 102, 104 and 106, respectively, are approximately one-half inch (½) in thickness. Collectively, first, second and third members 102, 104 and 106 approximately define a “frame” 105 of rod holder 100.

According to some embodiments, second member 104 includes a first holder 108a and a second holder 108b permanently or pivotably attached at either end thereof. Each holder 108a, 108b may be tubular, rectangular or any other suitable geometric configuration; however, in any embodiment, holders 108a, 108b should be sized to receive and hold a handle portion of a conventional fishing pole 110a, 110b in an angled position (i.e., when positioned within the holders 108a, 108b, the fishing poles 110a, 110b are in angled position). Holders 108a, 108b may be hollow or may include a bottom (not shown). In other embodiments, one or more holders may be attached to second member 104. According to embodiments of the invention, holders 108a, 108b may be angled at approximately forty-five (45) degrees relative to second member 104.

According to some embodiments, a flat or substantially flat panel 112 having a slit-like opening 114 (at or near an uppermost edge of panel 112) may reversibly secure to first member 102 by a locking mechanism 116 in a first position. Second member 104 and third member 106 assist in securing panel 112 against first member 102. In some embodiments, locking mechanism 116 may be a standard screw paired to a standard wing nut such as known by one ordinary skill in the art. In this manner, when the wing nut is turned so the wings are parallel relative to opening 114, the panel 112 may be removed from the frame 105. When the wing nut is turned so the wings are perpendicularly-oriented relative to opening 114, the panel 112 is locked in place.

Panel 112 may be approximately rectangular and may have a width of between four (4) inches and ten (10) inches and a length of between six (6) inches and twelve (12) inches. In the first position, one width edge of panel 112 may be adjacent and approximately parallel to second member 104 while a second opposite width edge of panel 112 may be adjacent and approximately parallel to third member 106. In any embodiment, panel 112 should have a width less than the length of the second member 104. In some embodiments, panel 112 is made of wood, steel, a composite material or any other suitable material. In any embodiment the material may be bacteria-resistant or treated with a bacteria-resistant substance. In the first position, opening 114 of panel 112 may be used as a handhold to carry and transport rod holder 100. Furthermore, in the first position, panel 112 serves as a reinforcement when rod holder 100 is being carried/transported.

According to some embodiments, a third holder 118a and a fourth holder 118b are permanently or reversibly attached to a bottom face of panel 112. Each holder 118a, 118b may be tubular, rectangular or any other suitable geometric configuration; however, in any embodiment, holders 118a, 118b should be sized to receive and hold a handle portion of a fishing pole in a vertically-oriented position. Holders 118a, 118b may be hollow or may include a bottom (not shown). In other embodiments, one or more holders may be attached to panel 112.

FIG. 2 is a perspective view of the transportable fishing rod holder 100 of FIG. 1 with panel 112 in a second position. As shown, in the second position, panel 112 (having opening 114) is approximately perpendicularly-oriented relative to first member 102 at approximately the middle thereof. Panel 112 may be held in the second position by a retaining mechanism 120 such as, but not limited to, a cantilever mechanism, i.e., two retaining members 107 perpendicularly-oriented relative to first member 102 and permanently affixed thereto. Retaining members 107 are distanced from one another at the same or substantially the same as the thickness of panel 112. In the second position, panel 112 may be used as a table to fillet freshly caught fish, hold bait or on which to set any other items. Also shown in FIG. 2 is second member 104 with holders 108a, 108b integrally attached at either end thereto. Also shown in FIG. 2 is third member 106 and a partial view of a securing mechanism 122 which may be used to secure rod holder 100 into the ground. According to some embodiments, securing mechanism 122 may be approximately perpendicularly-oriented relative to third member 106 and may be permanently or adjustably attached at approximately a middle thereof.

FIG. 3 is a perspective view of securing mechanism 122 which may be integral with the transportable fishing rod holder 100 of FIG. 1 and used to secure rod holder 100 into the ground. As shown, securing mechanism 122 may approximate a dual-member prong in configuration; however, other configurations are within the scope of the invention, e.g., three-member prong, etc. According to some embodiments, securing mechanism 122 may be used to secure rod holder 100 into the ground by applying pressure thereto, i.e., with a foot. The dual-member prong configuration of securing mechanism 122 provides at least twice as much support as a conventional rod holder comprising a single prong. Moreover, the orientation of securing mechanism 122 relative to first member 102 and third member 106 provides additional support and/or stability. Moreover, the top portion of securing mechanism 122 provides sufficient leverage to drive securing mechanism 122 into the ground even if the ground is unusually hard, impacted and/or rocky. In one embodiment, securing mechanism 122 is comprised of a steel rod welded at the respective location discussed above. In some embodiments, securing mechanism 122 is approximately one-half inch in thickness.

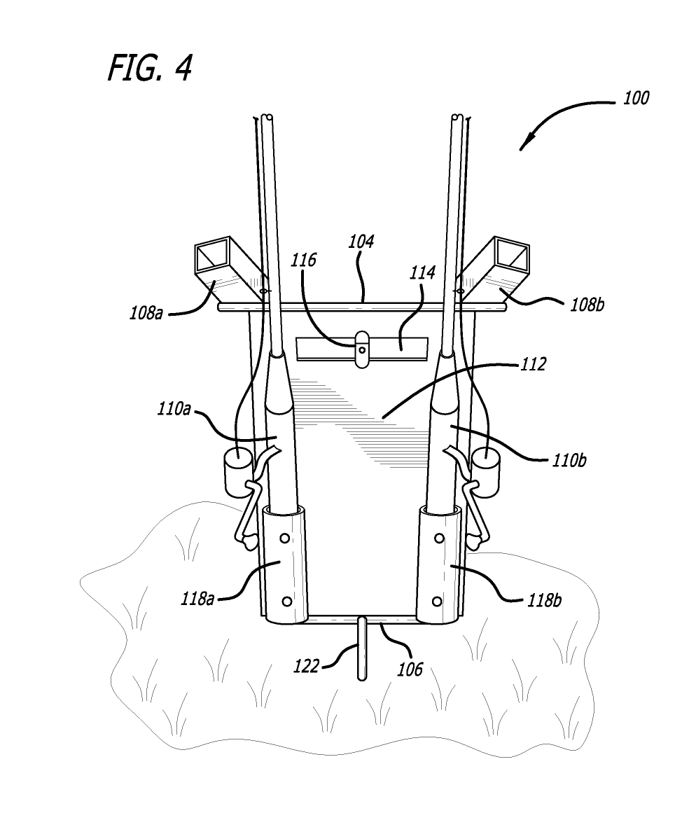

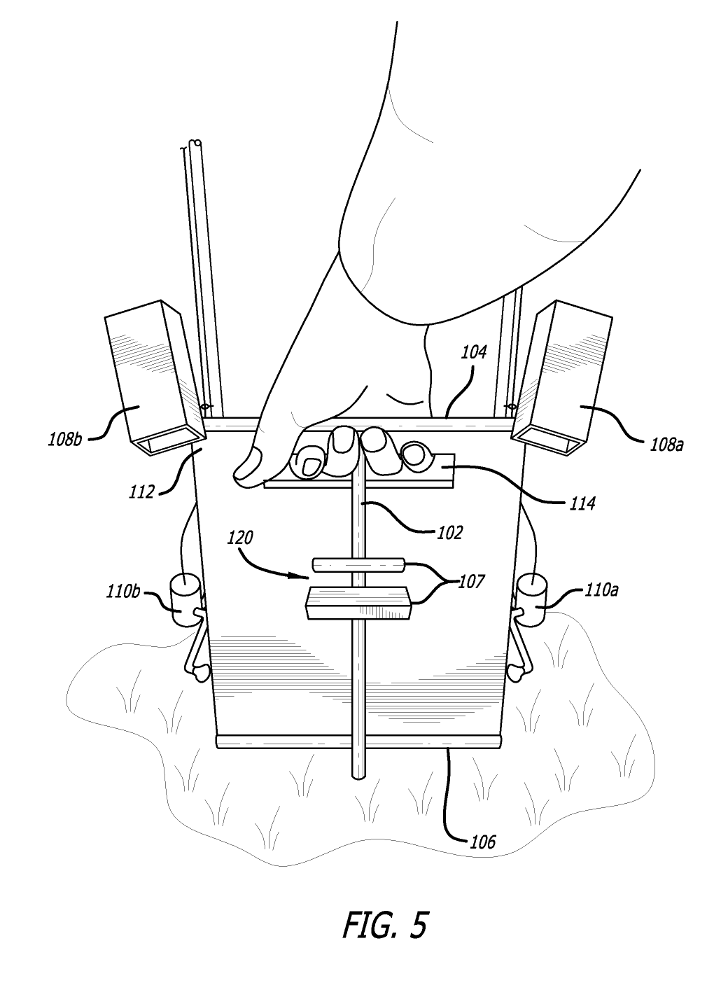

FIG. 4 is a front view of the transportable fishing rod holder 100 of FIG. 1 with fishing rods in storage. Similar to FIG. 1, FIG. 4 shows second member 104 with rod holders 108a, 108b at either end thereto; third member 106; a partial view of securing mechanism 122; and the bottom face of panel 112 (having opening 114 and secured by securing mechanism 116) with holders 118a, 118b attached thereto. However, in this view, fishing poles 110 are positioned within holders 118a, 188b and therefore the rod holder 100 is ready for transport. FIG. 5 is a view of the rod holder 100 being transported having the components discussed with reference to FIGS. 1-5.

The transportable fishing rod holder according to embodiments of the invention as previously described provides numerous advantages over conventional rod holders. For example, the rod holder is durable, provides superior stabilization relative to conventional holders and conveniently includes a fillet panel which alleviates the necessity to carry extra equipment.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A transportable fishing rod holder, comprising:
a first member;
a second member perpendicularly-attached at a proximal end of the first member at a middle of the second member, the second member including at least one angled holder at an end thereof;
a third member perpendicularly-attached at a distal end of the first member at a middle of the third member;
a securing mechanism having a dual-prong configuration adapted to secure in the ground, the securing mechanism attached to at least the third member at the middle thereof and perpendicularly-oriented relative to the third member; and
a removable panel having an slit-like opening therein and adapted to secure to the first member by a locking mechanism in a first position, the removable panel having at least one vertically-oriented holder attached thereto.

2. The transportable fishing rod holder of claim 1 wherein the removable panel is adapted to secure to the first member by two retaining members in a second position.

3. The transportable fishing rod holder of claim 1 wherein the first, second and third members are comprised of metal rods.

4. The transportable fishing rod holder of claim 3 wherein the securing mechanism is comprised of a metal rod.

5. The transportable fishing rod holder of claim 1 wherein the angled holder is adapted to hold a handle of a fishing pole.

6. The transportable fishing rod holder of claim 1 wherein the vertically-oriented holder is adapted to hold a handle of a fishing pole.

7. The transportable fishing rod holder of claim 1 wherein the second member includes two angled holders at either end thereto.

8. The transportable fishing rod holder of claim 1 wherein the panel includes two vertically-oriented holders.

9. A transportable fishing rod holder system, the system comprising:
a frame comprising two horizontally-oriented members affixed to a vertically-oriented member at either end of the vertically-oriented member;
a securing mechanism having a dual-prong configuration adapted to secure in the ground, the securing mechanism attached to one of the horizontally-oriented members at the middle thereof and perpendicularly-oriented relative thereto;
a removable panel having an slit-like opening therein, the panel adapted to secure to the frame by a locking mechanism in a first position, the panel adapted to secure to the frame by two retaining members in a second position wherein the panel is flush with the frame in the first position and wherein the panel is horizontally-oriented relative to the frame in the second position; and
at least one vertically-oriented holder attached to the panel.

10. The transportable fishing rod holder system of claim 9 wherein an opposing horizontally-oriented member includes at least one angled holder at an end thereof.

11. The transportable fishing rod holder system of claim 9 wherein the removable panel is adapted to secure to the vertically-oriented member by two retaining members in the second position.

12. The transportable fishing rod holder system of claim 9 wherein the horizontally and vertically-oriented members are comprised of metal rods.

13. The transportable fishing rod holder system of claim 9 wherein the securing mechanism is comprised of a metal rod.

14. The transportable fishing rod holder system of claim 10 wherein the angled holder is adapted to hold a handle of a fishing pole.

15. The transportable fishing rod holder system of claim 9 wherein the vertically-oriented holder is adapted to hold a handle of a fishing pole.

16. The transportable fishing rod holder system of claim 10 wherein the second member includes two angled holders at either end thereto.

17. The transportable fishing rod holder system of claim 9 wherein the panel includes two vertically-oriented holders.
